(19) United States
(12) Patent Application Publication
(10) Pub. No.: US 2020/0273039 A1
(43) Pub. Date: Aug. 27, 2020

(54) SYSTEMS AND METHODS FOR AUTOMATED FRAUD-TYPE IDENTIFICATION AND DECISIONING

(71) Applicant: JPMORGAN CHASE BANK, N.A., New York, NY (US)

(72) Inventors: Sunil MATHUR, Hockessin, DE (US); Dana E. RUST, Wilmington, DE (US); Stanley A. SZWALBENEST, Newtown, PA (US); James J. WHITE, Mullica Hill, NJ (US); Craig M. MULLANEY, Newark, DE (US); Michael SPILOTRO, Huntley, IL (US); Chad GOLDEN, Crystal Lake, IL (US); Kyle GNAGY, Powell, OH (US)

(21) Appl. No.: 16/800,474

(22) Filed: Feb. 25, 2020

Related U.S. Application Data
(60) Provisional application No. 62/810,102, filed on Feb. 25, 2019.

(51) Int. Cl. G06Q 20/40; G06Q 20/36; G06Q 20/38

(52) U.S. Cl. CPC G06Q 20/4016; G06Q 20/36; G06Q 2220/00; G06Q 20/3825; G06Q 20/407

(57) ABSTRACT

Systems and methods for automated fraud-type identification and decisioning are disclosed. In one embodiment, a method may include: (1) receiving, from a fraud detection system, an identification of a fraudulent transaction with a merchant; (2) determining that the fraudulent transaction was conducted using a digital wallet; (3) determining that the fraudulent transaction is associated with a linked merchant account; (4) retrieving a transaction history with the merchant and determining that the fraudulent transaction is a result of merchant account take over by: (a) determining that the transaction history only includes valid transactions with the merchant prior to the fraudulent transaction; (b) determining that the transaction history includes only valid digital wallet transactions with the merchant prior to the fraudulent transaction; and (c) determining that the transaction history includes a digital wallet transaction. with the linked merchant account.

### RELATED APPLICATIONS

This application claims priority to, and the benefit of, U.S. Provisional Patent Application Ser. No. 62/810,102, filed Feb. 25, 2019, the disclosure of which is hereby incorporated, by reference, in its entirety.

### FIELD OF THE INVENTION

The present disclosure relates generally to systems and methods for automated fraud-type identification and decisioning.

### DESCRIPTION OF THE RELATED ART

Digital wallets allow users to conduct electronic transactions, such as purchasing items on-line or at a store, with ease. A user's bank account may be linked to the digital wallet, and the digital wallet may require a login or other form of user authentication in order to conduct a transaction. Digital wallets may be used to conduct transactions with point of sale devices and with online merchants.

Digital wallets may be a target for fraud, in particular, account takeover (ATO). ATO is a form of identity theft where a bad actor gains unauthorized access to an account belonging to someone else. With digital wallets, there are at least two kinds of ATOs—digital wallet ATOs and merchant. ATOs. In the case of a. digital wallet ATO, the bad actor may gain unauthorized access to the digital wallet account. In the case of a merchant ATO, the bad actor may gain unauthorized access to a merchant account to which a digital wallet has previously been linked. If a linked merchant's account is compromised, the linked digital wallet is also compromised. Regardless of the type of ATO, the fraud affects the digital wallet provider because the digital wallet may be used to make the transaction.

One problem with tokenized transactions with a linked merchant account is that when ATO fraud occurs, the digital wallet provider may be unable to determine readily whether the fraud was digital wallet ATO or merchant ATO. It is advantageous for the wallet provider to know the type of fraud that occurred because it may affect liability (e.g., with merchant ATO, the digital wallet provider may initiate a chargeback on the transaction) and because it may assist the digital wallet provider in identifying and responding to unauthorized access to its systems.

### SUMMARY OF THE INVENTION

Systems and methods for automated fraud-type identification and decisioning are disclosed. In one embodiment, in an information processing apparatus comprising at least one computer processor, a method for identifying a fraud type in fraudulent digital wallet transactions may include: (1) receiving, from a fraud detection system, an identification of a fraudulent transaction with a merchant; (2) determining that the fraudulent transaction was conducted using a digital wallet; (3) determining that the fraudulent transaction is associated with a linked merchant account; (4) retrieving a transaction history with the merchant and determining that the fraudulent transaction is a result of merchant account take over by: (a) determining that the transaction history only includes valid transactions with the merchant prior to the fraudulent transaction; (b) determining that the transaction history includes only valid digital wallet transactions with the merchant prior to the fraudulent transaction; and (c) determining that the transaction history includes a digital wallet transaction with the linked merchant account.

In one embodiment, the determination that the fraudulent transaction was conducted using a digital wallet may be based on a channel identification for the fraudulent transaction.

In one embodiment, the determination that the fraudulent transaction was conducted using a digital wallet may be based on a API used by the merchant to conduct the fraudulent transaction.

In one embodiment, the determination that the fraudulent transaction is associated with a linked merchant account may be based on a merchant identifier associated with the fraudulent transaction.

In one embodiment, the determination that the fraudulent transaction is associated with a linked merchant account may be based on a API used by the merchant to conduct the fraudulent transaction.

In one embodiment, the transaction history may be received for a predetermined period of time.

In one embodiment, the fraudulent transaction may be determined to be the result of digital wallet takeover when the fraudulent transaction was not conducted using a digital wallet or when the fraudulent transaction was not associated with a linked merchant account.

In one embodiment, the fraudulent transaction may be determined to be the result of digital wallet takeover when the transaction history does not include a valid transaction with the merchant prior to the fraudulent transaction, when the transaction history does not include a valid digital wallet transaction with the merchant prior to the fraudulent transaction, or when the transaction history does not include a transaction with the linked merchant account.

In one embodiment, the method may further include closing an account associated with the digital wallet.

In one embodiment, the method may further include determining that the fraudulent transaction is eligible for a chargeback; and automatically generating a chargeback for the fraudulent transaction.

In one embodiment, the method may further include invalidating a third-party token associated with the digital wallet.

In one embodiment, the method may further include blacklisting an electronic device associated with the digital wallet.

According to another embodiment, in an information processing apparatus comprising at least one computer processor, a method for identifying a fraud type in fraudulent digital wallet transactions may include: (1) receiving, from a fraud detection system, an identification of a fraudulent transaction with a merchant; (2) determining that the fraudulent transaction was conducted using a digital wallet; (3) determining that the digital wallet is linked to a merchant account; (4) determining that the fraudulent transaction is a result of merchant account take over by: (5) determining that the digital wallet was linked to the merchant account for longer than a predetermined period of time; (6) retrieving digital wallet transaction history for the digital wallet; and (7) determining that the digital wallet history includes a valid transaction with the merchant prior to the fraudulent transaction.

In one embodiment, the determination that the fraudulent transaction was conducted using a digital wallet may be based on a channel identification for the fraudulent transaction.

In one embodiment, the determination that the fraudulent transaction was conducted using a digital wallet may be based on a API used by the merchant to conduct the fraudulent transaction.

In one embodiment, the predetermined period of time may be 48 hours.

In one embodiment, the fraudulent transaction is determined to be the result of digital wallet takeover when the fraudulent transaction was not conducted using a digital wallet or when the fraudulent transaction was not associated with a linked merchant account.

In one embodiment, the fraudulent transaction is determined to be the result of digital wallet takeover when the digital wallet has not been linked to the merchant account for longer than a predetermined period of time or when the digital wallet history does not include a transaction with the linked merchant account.

In one embodiment, the method may further include closing an account associated with the digital wallet.

In one embodiment, the method may further include blacklisting an electronic device associated with the digital wallet.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for automated fraud-type identification and decisioning according to one embodiment;

FIG. 2 depicts a method for automated fraud-type identification and decisioning according to one embodiment;

FIG. 3 depicts a method for taking an action based on the automated fraud-type identification according to one embodiment; and

FIG. 4 depicts a method for identifying a fraud type in a digital wallet transaction based on when a merchant wallet was linked according to one embodiment.

### DETAILED DESCRIPTION

Exemplary embodiments will now be described in order to illustrate various features. The embodiments described herein are not intended to be limiting as to the scope, but rather are intended to provide examples of the components, use, and operation of the invention.

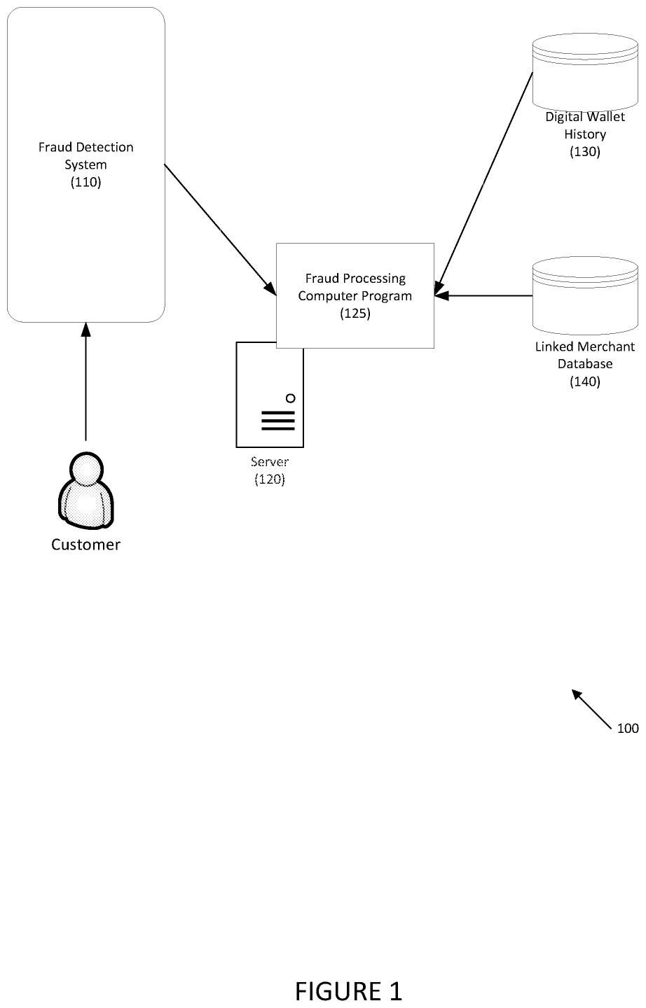

FIG. 1 depicts a system for automated fraud-type identification and decisioning according to one embodiment. System 100 may include fraud detection system 110 that may be any suitable system that identifies potential fraud in a transaction. Any suitable fraud detection system may be used as is necessary and/or desired.

In one embodiment, fraud detection system 110 may identify fraud in a digital wallet-based transaction. For example, the digital wallet may be financial institution-based digital wallet.

Server 120 may execute fraud processing computer program 125. In one embodiment, server 120 may include one or more physical server, one or more cloud-based server, combinations thereof, etc.

System 100 may further include digital wallet history 130, which may store details regarding digital wallet history, such as wallet transaction history, wallet linking history, etc.

System 100 may further include linked merchant database 140, which may store data on merchants with which digital wallets are linked.

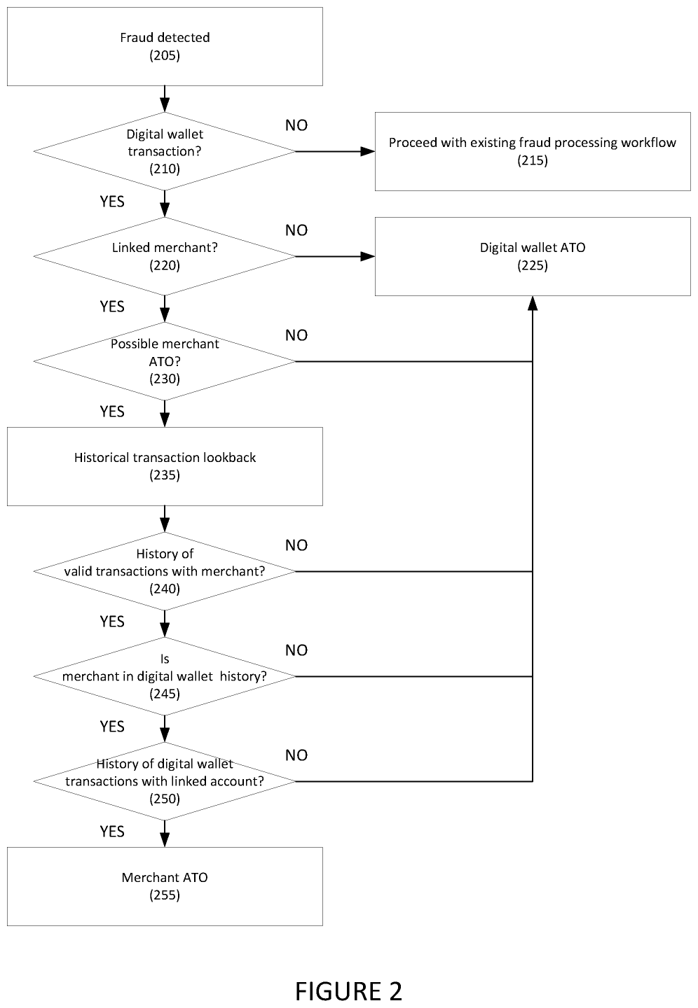

FIG. 2 depicts a method for automated fraud-type identification and decisioning according to one embodiment. In one embodiment, the fraud type may be identified based on a lookup of digital wallet transaction history according to one embodiment.

In step 205, fraud is detected for a transaction, and transaction information may be passed to the fraud identification process. Fraud may be detected, for example, by fraud detection systems, by a customer reporting fraud to the digital wallet provider, etc. Any suitable fraud detection system may be used as is necessary and/or desired.

In step 210, a determination may be made whether the fraudulent transaction is associated with a digital wallet. This determination may be made, for example, based on a channel ID for the transaction that indicates whether federated authentication was used, based on an API used by the merchant for the transaction, etc.

If the transaction is not associated with a digital wallet, in step 215, the fraud may be processed according to an existing fraud processing workflow.

If the transaction was conducted with a digital wallet, in step 220, a determination is made as to whether the transaction is associated with a linked merchant account. In one embodiment, the determination may be based on the merchant ID. For example, a transaction using tokenized authentication associated with a linked merchant account may have a merchant ID, identifying it as a linked transaction.

If the digital wallet transaction is not associated with a linked merchant account, in step 225, the fraud is classified as digital wallet ATO.

If the transaction is associated with a linked merchant account, in step 230, a determination is made as to whether merchant ATO is possible with the merchant account in question. In one embodiment, the determination as to whether merchant ATO is possible may be based on the merchant ID information. For example, the digital wallet provider may have a list of merchant IDs for which merchant ATO is possible.

In another embodiment, the determination as to whether merchant ATO is possible may be based on the API used by the merchant to communicate transactions. For example, if the merchant has previously communicated transactions through a particular API, it may be determined that merchant ATO is possible.

If ATO is not possible with the merchant account, in step 225, the fraud is identified as digital wallet ATO.

If merchant ATO is possible, in step 235, a systemic historical transaction lookback may be initiated to retrieve the customer's transaction history with the merchant, including the customer's digital wallet transaction history with the digital wallet. In one embodiment, one or more inquiry, such as those depicted in steps 240, 245, and 250 may be required to be satisfied in order for the transaction to be classified as a merchant ATO. If one or more of steps 240, 245, and 250 are not satisfied, the transaction may be classified as digital wallet ATO.

In step 240, a determination is made whether the customer has a history of valid (e.g., non-fraudulent or non-disputed transactions) with the merchant. A history of non-fraudulent or non-disputed transactions with the merchant likely indicates that the fraud is a result of merchant ATO. If there is a history of fraudulent or disputed transactions with the merchant (e.g., one or more), this likely indicates digital wallet ATO.

In step 245, a determination may be made whether the merchant appears in the digital wallet transaction history. In one embodiment, the inquiry may be for prior activity between the customer and the merchant that is valid/not fraud to understand if the customer previously conducted business with that merchant and had a profile (may not be digital wallet) setup with that merchant. For example, if a transaction involving the merchant does appear in the digital wallet history, this likely indicates that the fraud is a result of merchant ATO. If there are not any transactions involving the merchant in the digital wallet history, this likely indicates digital wallet ATO.

In step 250, a determination may be made whether there is a history of digital wallet transactions with the linked merchant account. For example, if there is a transaction involving the merchant linked account in the digital wallet history, this likely indicates that the fraud is a result of merchant ATO. If there are not any transactions involving the merchant linked account in the digital wallet history, this likely indicates digital wallet ATO.

If an affirmative determination is made in each of steps 240, 245, and 250, in step 255, the digital wallet transaction may be identified as merchant ATO.

In one embodiment, the information available to the fraud identification process may include merchant IDs, transaction IDs, transaction amounts, and transaction dates for a certain time period (e.g., starting at six months from the fraudulent transaction up until the fraudulent transaction under investigation), etc.

In another embodiment, the information available to the fraud identification process may further include a customer ID (for example, a login username or email address), a channel ID, the tenure of the digital wallet, the method for customer authentication (for example, by PIN, password, biometrics (e.g., fingerprint, face recognition), etc.), the date the digital wallet was linked to the merchant account, whether any additional merchant accounts are linked with the digital wallet, and any other information as is necessary and/or desired.

In one embodiment, if the transaction is identified as digital wallet ATO, the transaction information may be sent to a consumer protection group within the digital wallet provider's organization.

In one embodiment, if the transaction is identified as merchant ATO, a recommendation may be made by the fraud identification system to contact the customer to advise of merchant account takeover.

In one embodiment, the results may be provided to the fraud identification system(s) so that the fraud identification systems may update their rules.

In embodiments, a score may be assigned to each part of the merchant ATO inquiry, and a composite score may be shared across multiple platforms. For example, one financial institution may share its score with another financial institution that may hold an account for the customer or merchant in question in order to improve its fraud processing capabilities.

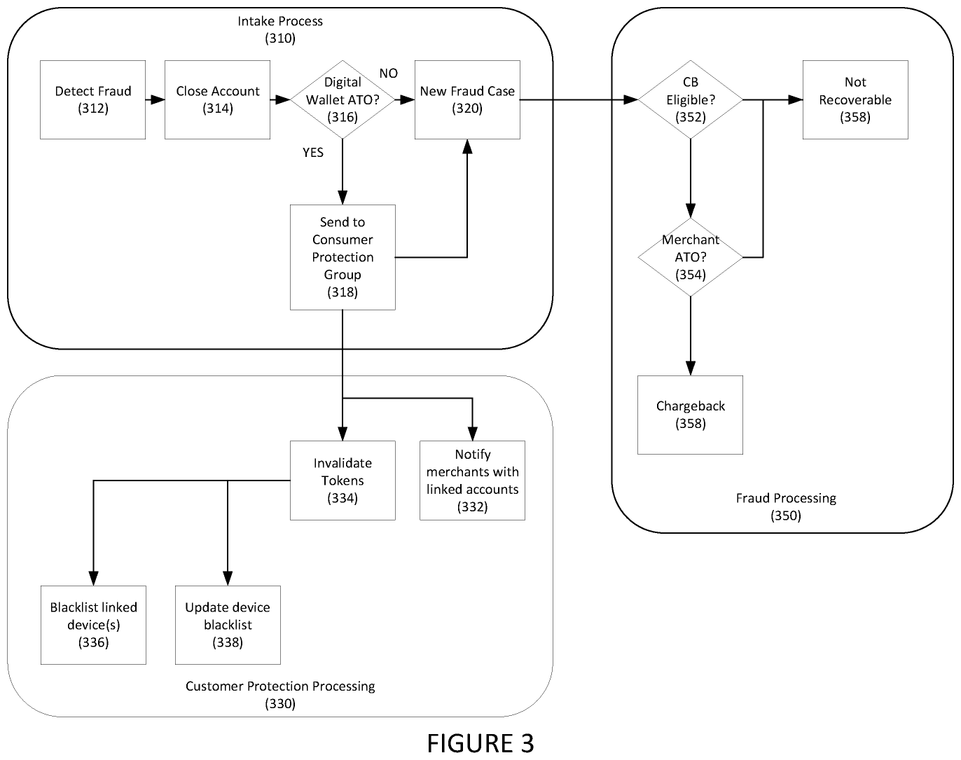

FIG. 3 depicts a method for taking an action based on the automated fraud-type identification according to one embodiment. FIG. 3 depicts three general processes—intake process 310, customer protection processing 330, and fraud processing 350.

In step 312 of intake process 310, fraud is detected, and the fraud type is determined by, for example, the process of FIG. 2. In step 314, the digital wallet account for which the fraudulent transaction was detected may be closed. At this step, the customer may be automatically un-enrolled from the digital wallet service, his or her online profile may be suspended, and any tokens for tokenized transactions with other merchants may be invalidated.

In step 316, if the fraud was identified as digital wallet ATO, in step 318, the transaction information may be sent to a consumer protection group (CPG) within the digital wallet provider's organization for consumer protection processing 330, such as to secure assets and confirm the source of fraud.

If consumer protection processing is initiated, in step 332, merchants with merchant accounts that are linked to the digital wallet may be automatically notified of the digital wallet ATO.

In step 334, some or all third-party tokens for the digital wallet may be invalidated. Upon confirmation of fraud, the fraud systems may inform the digital systems of the token used for fraud. The digital system may automatically invalidate the token used for fraud, may invalidate the customer's digital wallet, and may suspend the customer's online bank profile.

In one embodiment, tokens may be invalidated in whichever digital system manages the tokens. The digital system that manages the tokens, for example, may recognize tokens associated with a specific wallet and any wallets that are linked for a customer.

In step 336, if the digital wallet is associated with a device, the device may be automatically blacklisted from accessing the digital wallet, and in step 338, the digital wallet provider blacklist may then be updated. Regardless of whether the fraud was identified as digital wallet ATO or merchant ATO, in step 320 a new fraud processing case may be created and fraud processing 350 is initiated.

In step 352, a determination may be made as to whether the transaction is eligible for a chargeback (CB-eligible). If it is not, in step 354, the transaction may be flagged as not recoverable, and chargebacks may be suppressed. If the transaction is eligible for a chargeback, in step 356, the fraud type may be checked. If the fraud type was identified as merchant ATO, in step 358, a chargeback may be generated. If the fraud was identified as digital wallet ATO, in step 354, the transaction may be flagged as not recoverable and chargebacks are suppressed.

In one embodiment, whether a chargeback is initiated at step 358 may depend additionally on whether there is a zero-fraud liability arrangement in place with the merchant or not.

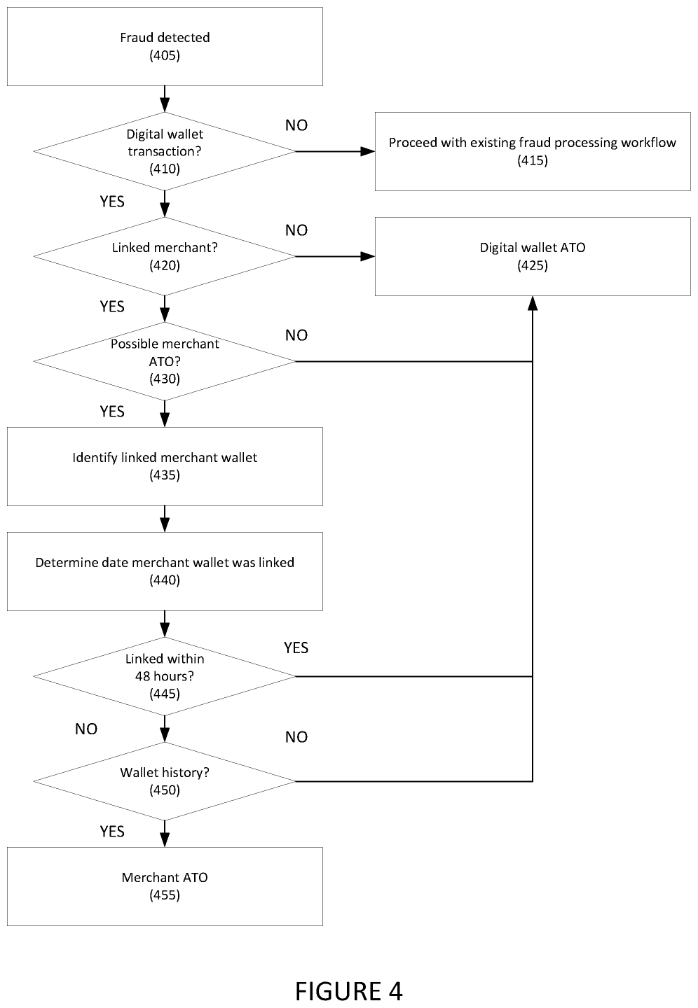

FIG. 4 depicts a method for identifying a fraud type in a digital wallet transaction based on when a merchant wallet was linked according to one embodiment.

In step 405, fraud is detected for a transaction, and transaction information may be passed to the fraud identification process. This may be similar to step 205, above.

In step 410, a determination may be made whether the fraudulent transaction is associated with a digital wallet or not. This may be similar to step 210, above. If not, the transaction may be processed according to the existing fraud processing workflow at step 415.

If the transaction is associated with a digital wallet, a determination is made at step 420 whether the digital wallet transaction is associated with a linked merchant account. This may be similar to step 220, above.

In step 425, if the transaction is not associated with a linked merchant account, the fraud is classified as digital wallet ATO. This may be similar to step 225, above.

If, in step 430, the transaction is with a linked merchant account, an additional determination is made whether merchant ATO is possible with the merchant account in question. This may be similar to step 230, above. If ATO is not possible with the merchant account, in step 425, the fraud is identified as digital wallet ATO.

If merchant ATO is possible, in step 435, the linked merchant wallet may be identified, and, in step 440, the date and time at which the merchant wallet was linked is determined.

In step 445, a determination may be made whether the merchant wallet was linked within a certain timeframe, such as within 48 hours or any other desirable timeframe. If the merchant wallet was linked within the certain timeframe, in step 425, the transaction may be categorized as digital wallet ATO.

In step 450, a determination may be made whether the merchant appears in the linked merchant wallet transaction history. If the merchant is not in the linked merchant wallet transaction history, in step 425, the transaction may be categorized as digital wallet ATO.

If the merchant is in the linked merchant wallet transaction history, in step 455, the digital wallet transaction may be identified as merchant ATO.

In one embodiment, the results may be provided to the fraud identification system(s) so that the fraud identification systems may update their rules.

In another embodiment, the merchant ATO workflow may further include checking the transaction history of other transactions conducted with the customer's digital wallet using the same linked merchant account identifier as the fraudulent transaction. For example, an additional determination may be made whether the customer's linked merchant account appears in the digital wallet transaction history of any of the customer's linked accounts.

Embodiments may provide advantages by allowing easy identification of fraud type in digital wallet transactions, including the ability to distinguish between wallet-provider ATO and merchant ATO in tokenized transactions. This classification may be performed as soon as the fraud is detected, or whenever necessary and/or desired. Further, actions based on fraud type may be executed automatically, which may protect the digital wallet provider and user from the existing fraud or further fraud. All identification and decision-making may be automated from the moment of fraud detection.

Hereinafter, general aspects of implementation of the systems and methods of the embodiments will be described.

The system of the embodiments or portions of the system of the embodiments may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the embodiments.

The processing machine used to implement the embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the methods as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the embodiments. Rather, any number of different programming languages may be utilized as is necessary and/or desirable.

Also, the instructions and/or data used in the practice of the embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the embodiments.

Further, the memory or memories used in the processing machine that implements the embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the embodiments, a variety of “user interfaces” may be utilized to allow a user to interface with the processing machine or machines that are used to implement the embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method of the embodiments may interact partially with another processing machine or processing machines, while also interacting partially with a human user.

It will be readily understood by those persons skilled in the art that the present embodiments are susceptible to broad utility and application. Many embodiments and adaptations other than those herein described, as well as many variations, modifications and equivalent arrangements, will be apparent from or reasonably suggested by the present embodiments and foregoing description thereof, without departing from the substance or scope of the invention.

Accordingly, while the present exemplary embodiments have been described here in detail, it is to be understood that this disclosure is only illustrative and exemplary and is made to provide an enabling disclosure of the invention. Accordingly, the foregoing disclosure is not intended to be construed or to limit the present embodiments or otherwise to exclude any other such embodiments, adaptations, variations, modifications or equivalent arrangements.

What is claimed is:

1. A method for identifying a fraud type in fraudulent digital wallet transactions, comprising:
in an information processing apparatus comprising at least one computer processor:
receiving, from a fraud detection system, an identification of a fraudulent transaction with a merchant;
determining that the fraudulent transaction was conducted using a digital wallet;
determining that the fraudulent transaction is associated with a linked merchant account;
retrieving a transaction history with the merchant and determining that the fraudulent transaction is a result of merchant account take over by:
determining that the transaction history only includes valid transactions with the merchant prior to the fraudulent transaction;
determining that the transaction history includes only valid digital wallet transactions with the merchant prior to the fraudulent transaction; and
determining that the transaction history includes a digital wallet transaction with the linked merchant account.

2. The method of claim 1, wherein the determination that the fraudulent transaction was conducted using a digital wallet is based on a channel identification for the fraudulent transaction.

3. The method of claim 1, wherein the determination that the fraudulent transaction was conducted using a digital wallet is based on a API used by the merchant to conduct the fraudulent transaction.

4. The method of claim 1, wherein the determination that the fraudulent transaction is associated with a linked merchant account is based on a merchant identifier associated with the fraudulent transaction.

5. The method of claim 1, wherein the determination that the fraudulent transaction is associated with a linked merchant account is based on a API used by the merchant to conduct the fraudulent transaction.

6. The method of claim 1, wherein the transaction history is received for a predetermined period of time.

7. The method of claim 1, wherein the fraudulent transaction is determined to be the result of digital wallet takeover when the fraudulent transaction was not conducted using a digital wallet or when the fraudulent transaction was not associated with a linked merchant account.

8. The method of claim 1, wherein the fraudulent transaction is determined to be the result of digital wallet takeover when the transaction history does not include a valid transaction with the merchant prior to the fraudulent transaction, when the transaction history does not include a valid digital wallet transaction with the merchant prior to the fraudulent transaction, or when the transaction history does not include a transaction with the linked merchant account.

9. The method of claim 1, further comprising:
closing an account associated with the digital wallet.

10. The method of claim 1, further comprising:
determining that the fraudulent transaction is eligible for a chargeback; and
automatically generating a chargeback for the fraudulent transaction.

11. The method of claim 1, further comprising:
invalidating a third-party token associated with the digital wallet.

12. The method of claim 1, further comprising:
blacklisting an electronic device associated with the digital wallet.

13. A method for identifying a fraud type in fraudulent digital wallet transactions, comprising:
in an information processing apparatus comprising at least one computer processor:
receiving, from a fraud detection system, an identification of a fraudulent transaction with a merchant;
determining that the fraudulent transaction was conducted using a digital wallet;
determining that the digital wallet is linked to a merchant account;
determining that the fraudulent transaction is a result of merchant account take over by:
determining that the digital wallet was linked to the merchant account for longer than a predetermined period of time;
retrieving digital wallet transaction history for the digital wallet; and
determining that the digital wallet history includes a valid transaction with the merchant prior to the fraudulent transaction.

14. The method of claim 13, wherein the determination that the fraudulent transaction was conducted using a digital wallet is based on a channel identification for the fraudulent transaction.

15. The method of claim 13, wherein the determination that the fraudulent transaction was conducted using a digital wallet is based on a API used by the merchant to conduct the fraudulent transaction.

16. The method of claim 13, wherein the predetermined period of time is 48 hours.

17. The method of claim 13, wherein the fraudulent transaction is determined to be the result of digital wallet takeover when the fraudulent transaction was not conducted using a digital wallet or when the fraudulent transaction was not associated with a linked merchant account.

18. The method of claim 13, wherein the fraudulent transaction is determined to be the result of digital wallet takeover when the digital wallet has not been linked to the merchant account for longer than a predetermined period of time or when the digital wallet history does not include a transaction with the linked merchant account.

19. The method of claim 13, further comprising:
closing an account associated with the digital wallet.

20. The method of claim 13, further comprising:
blacklisting an electronic device associated with the digital wallet.
